(19) United States
(12) Patent Application Publication
(10) Pub. No.: US 2004/0200570 A1
(43) Pub. Date: Oct. 14, 2004

(54) Structure forming method and apparatus

(76) Inventor: LeRoy Payne, Billings, MT (US)

Correspondence Address: Arthur L Urban, HC 50 Box 4045, Red Lodge, MT, 59068, US

(21) Appl. No.: 10/483,549

(22) PCT Filed: Aug. 13, 2001
(86) PCT No.: PCT/US01/25740

(51) Int. Cl. C09J 1/00

(52) U.S. Cl. 156/276

(57) ABSTRACT

A method of forming a continuous composite structure (49) includes the steps of mixing in a chamber (39) a liquid reactive resin forming material, a catalyst, an inhibitor and a particulate solid additive material in proportions based on the ambient temperature. A pool (35) of the mixture is formed on a porous blanket (34) and part is migrated therethrough prior to gelling to a continuous resin matrix therein. Opposite edges (73,74) of a preselected length (72) are grasped creating a preselected tension in the blanket length (72) which is maintained while is maintained while transferring the blanket length (72) to a final location.

This application is a continuation-in-part of pending International application No. PCT/US00/19248, filed Jul. 13, 2000, which in turn is a continuation-in-part of pending International application No. PCT/US99/21675, filed Sep. 20, 1999, which in turn is a continuation-in-part of pending International application No. PCT/US98/23034, filed Oct. 30, 1998, which in turn is a continuation-in-part of pending International application No. PCT/US96/15499, filed Sep. 26, 1996, which in turn is a continuation-in-part of pending International application No. PCT/US96/05132, filed May 20, 1996, which in turn is a continuation-in-part of International application No. PCT/US95/05450, filed May 4, 1995, now U.S. Pat. No. 5,725,716, which in turn is a continuation-in-part of U.S. application Ser. No. 239,540, filed May 9, 1994, now U.S. Pat. No. 5,496,434, which in turn is a continuation-in-part of U.S. application Ser. No. 870,927, filed Apr. 20, 1992, now U.S. Pat. No. 5,330,603, which in turn is a continuation-in-part of U.S. application Ser. No. 753,344, filed Aug. 30, 1991, now U.S. Pat. No. 5,145,282, which in turn is a continuation-in-part of U.S. application Ser. No, 521,442, filed May 10, 1990, now U.S. Pat. No. 5,049,006, which in turn is a continuation-in-part of U.S. application Ser. No. 417,501, filed Oct. 5, 1989, now U.S. Pat. No. 4,955,760, which in turn is a continuation-in-part of U.S. application Ser. No. 235,205, filed Aug. 23, 1988, now U.S. Pat. No. 4,872,784.

This invention relates to a novel continuous structure forming method and apparatus.

The present invention provides a novel method and apparatus which overcome the shortcomings of previous expedients. In addition, the method and apparatus provide features and advantages not found in earlier technology.

The method and apparatus of the present invention may be employed by individuals with only limited mechanical skills and experience. Structures can be produced by such individuals safely and efficiently without supervision utilizing the method and apparatus of the invention. The method and apparatus of the invention can be modified to form a variety of structures.

A novel method of the present invention for forming a substantially continuous composite structure includes the steps of preselecting a liquid reactive resin forming material, a catalyst, an inhibitor, a particulate solid additive material and a porous blanket. The ambient temperature is measured and the relative proportions of the resin forming material, the catalyst and the inhibitor are determined based on the ambient temperature and the porous blanket.

The additive particles are mixed with the predetermined proportions of the resin forming material, the catalyst and the inhibitor substantially continuously. Substantially all of the additive particles are encapsulated with the catalyzed and inhibited resin forming material to a preselected thickness.

A pool of the mixture is formed on the blanket while it is moving over an elongated arcuate surface disposed in a preselected orientation. The mixture-treated blanket is advanced while migrating part of the catalyzed and inhibited resin forming material through the blanket substantially uniformly prior to gelling of the material to form a continuous resin matrix within the blanket.

A leading edge of the matrix/blanket is grasped along substantiallly its entire width and advanced away from the arcuate surface along a preselected path. Opposite edges of a preselected length of the matrix/blanket structure are grasped and a preselected tension created in the structure length.

The tension is maintained while the structure length is transferred to a final location. The structure length is deposited on a final surface while the length is flexible and adhesive. Pressure is applied to form a tight bond therebetween.

Advantageously, the tension is maintained while the structure length is placed into contact with the final surface. Preferably, the length of the structure is aligned into a preselected position before grasping opposite edges thereof. The structure length is lowered into a preselected position prior to grasping the opposite edges thereof. Preferably, transverse edges of the structure length are grasped.

The tensioned structure lengths may be transferred to a remote final location. Advantageously, a plurality of tensioned structure lengths are transferred sequentially to a common final location and deposited successively in an overlapping relationship to form a continuous structural assembly of considerable length. Alternatively, a plurality of structure lengths may be transferred successively to a plurality of spaced final locations arranged in a preselected pattern to form a plurality of spaced continuous structural assemblies arranged in a preselected pattern.

Benefits and advantages of the novel method and apparatus of the present invention will be apparent from the following description of the accompanying drawings in which:

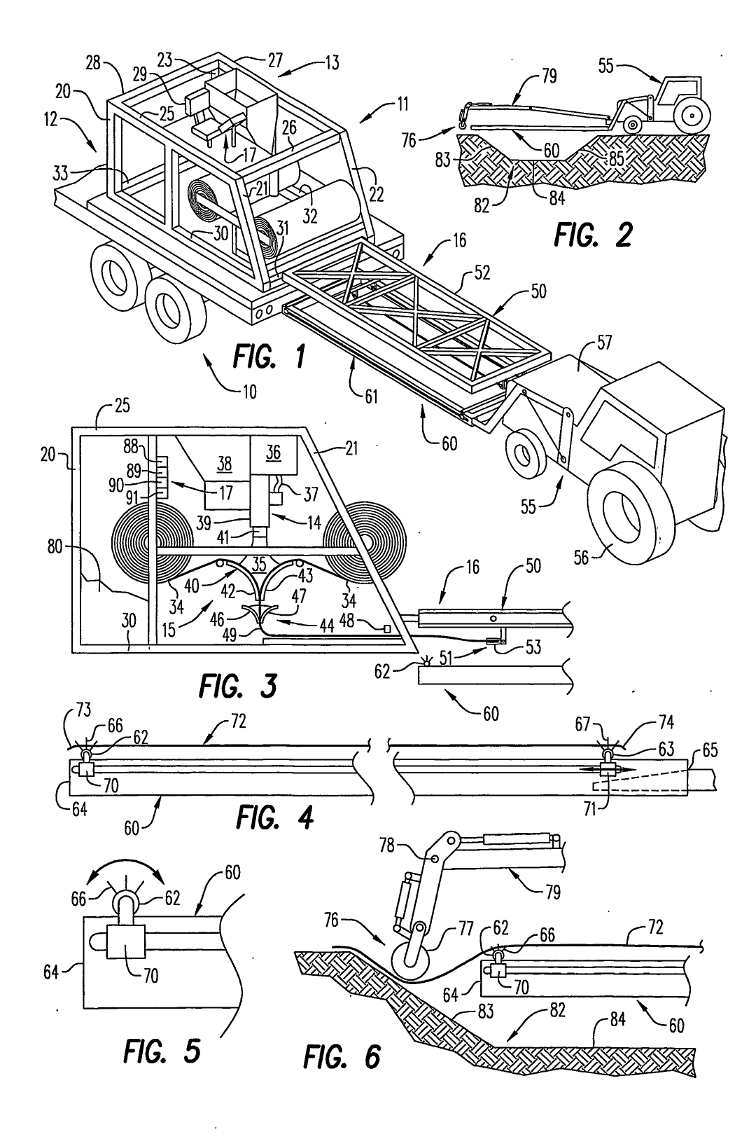

FIG. 1 is a view in perspective of one form of continuous structure forming apparatus of the present invention;

FIG. 2 is a reduced side view of the structure transferring assenbly of the structure forming apparatus of the invention shown in FIG. 1;

FIG. 3 is an enlarged fragmentary side view of the structure forming apparatus of the invention shown in FIG. 1;

FIG. 4 is a fragmentary cross sectional view of the structure tensioning portion of the structure forming apparatus of the invention shown in FIG. 1;

FIG. 5 is a greatly enlarged fragmentary side view of a tensioning rod member of the structure tensioning portion of the structure forming apparatus shown in FIG. 4; and

FIG. 6 is a greatly enlarged fragmentary side view of the structure transferring assembly shown in FIG. 2 in use.

As shown in the drawings, one form of novel continuous structure forming apparatus 11 of the present invention includes a supporting portion 12, a material supplying portion 13, a mixing portion 14, a matrix forming portion 15, a positioning portion 16 and a control portion 17.

The supporting portion 12 of the structure forming apparatus of the invention includes a plurality of spaced upstanding frame members 20, 21, 22, 23. A plurality of generally horizontally disposed frame members 25, 26, 27, 28 join adjacent upper ends of the upstanding frame members, and horizontal frame members 30, 31, 32, 33 join lower ends thereof.

Components of the material supplying portion 13, as well as other components such as an operator's seat 29 or electrical generators, air compressors, hydraulic pumps and the like (not shown), also can be mounted on and/or suspended from the frame members.

The material supplying portion 13 of the apparatus 11 includes a plurality of reservoirs 36 operatively connected with the supporting portion 12. The reservoirs are connected independently with the mixing portion 14, preferably through flexible conduit means 37. The material supplying portion also may include hoppers 38 adjacent the mixing portion.

The mixing portion 14 of the structure forming apparatus 11 of the invention includes an elongated mixing chamber 39 adjustably disposed on the supporting portion 12.

The matrix forming portion 15 of the apparatus 11 includes mixture distributing means 40 adjacent an outlet 41 of the mixing chamber 39 and adjustable downwardly therefrom. The mixture distributing means 40 as shown in the drawings includes a pair of spaced elongated transversely disposed arcuate members 42,43 with generally horizontal lower edges adjustably oriented closer together than upper edges thereof.

The matrix forming portion 15 also may include second mixture distributing means 44 adjacent the first mixture distributing means 40. The second mixture distributing means advantageously is disposed in a generally horizontal orientation. Preferably, the second mixture distributing means includes spaced arcuate members 46,47 disposed similarly to arcuate members 42,43. Advantageously, a reciprocating cutter mechanism 48 is mounted on the supporting portion subsequent to the second mixture distributing means.

The positioning portion 16 of the structure forming apparatus of the invention includes a generally horizontally disposed frame section 50 extending outwardly from supporting portion 12 adjacent the matrix forming portion 15. Positioning portion 16 includes elongated structure grasping means 51 translatably movable along the frame section 50.

Advantageously, the elongated structure grasping means 51 extends between and travels along spaced parallel side rails 52 of the frame section. The elongated structure grasping means 51 preferably includes a pair of cooperating hinged sections 53.

The positioning portion 16 of the structure forming apparatus 11 of the invention also includes a structure transferring assembly 55 that is alignable with the frame section 50. The structure transferring assembly advantageously includes wheeled carriages 56, preferably with drive means 57.

The positioning portion 16 further includes structure tensioning means 60. The tensioning means advantageously includes an open peripheral section 61. The peripheral section includes rod members 62,63 along opposite sides 64,65 thereof. A plurality of spaced pins 66,67 extend outwardly from each of the rod members 62,63 respectively, along the length of each rod member.

Actuating means 70,71 selectively engage the pins 66,67 with a structure length 72 adjacent opposite edges 73,74 thereof. Also, the means 70,71 change the spacing between the pins 66 of rod member 62 and the pins 67 of rod member 63. As shown in FIG. 5, spacing between the respective pins can be changed by rotating one or both rod members about their respective axes. This rotation creates a preselected tension in the structure length.

The positioning means 50 also may include pressure applying means 76. The pressure applying means advantageously includes a pressure roller 77 which as shown in FIG. 2 may be disposed on the free end 78 of an extendable arm member 79 that is mounted on the structure transferring assembly 55.

Preferably, the apparatus 11 includes outer shell sections 80 selectively hung from the apparatus to enclose the apparatus during storage. Also, the shell sections help to control wind, temperature, other weather conditions, etc. during operation.

In the formation of a substantially continuous composite structure with the apparatus 11 of the invention as shown in the drawings, the apparatus disposed on a trailer or truck bed 10 is transferred to a job site and positioned adjacent thereto.

Operation of the structure forming apparatus 11 is begun by preselecting a liquid reactive resin forming material, a catalyst, an inhibitor, particulate solid additive material and a porous blanket. The ambient temperature is measured. With this information, the relative proportions of the resin forming material, catalyst and inhibitor are determined based on the ambient temperature and the construction of the porous blanket.

The liquid reactive resin forming material is advanced from reservoir 36 through conduit 37 into mixing chamber 39. Simultaneously, other ingredients e.g. particulate solid additive materials, colors, catalysts, inhibitors, etc. from other reservoirs (not shown) are advanced continuously through conduits into the mixing chamber 39. During this continuous mixing operation, substantially all of the additive particles are encapsulated with the catalyzed and inhibited resin forming material.

The resulting mixture being delivered from outlet 41 of the mixing chamber 39 passes downwardly between arcuate members 42,43 into contact with a porous blanket or blankets 34 moving therethrough. The mixture is delivered at a rate sufficient to form a residual pool 35 between the arcuate members. As the blanket exits the liquid pool, part of the mixture migrates through the blanket substantially uniformly to form a continuous resin matrix within the blanket with the outer surfaces being adhesive.

The matrix/blanket structure 49 then is advanced by grasping means 51 along the length of frame section 50. The resulting structure then is cut into preselected lengths 72 and individually permitted to settle onto a structure transferring assembly 55 aligned with the frame section.

Rod members 62,63 are rotated slightly to move pins 66,67 extending therefrom into engagement with opposite edges 73,74 of the structure length 72. Thereafter, rotation of rod members 62,63 by actuating means 70,71 is continued to increase the spacing between the pins 66,67 of the respective rod members. This creates tension in the structure to a preselected level within peripheral section 61.

The transferring assembly 55 supporting the peripheral section with the tensioned structural length 72 is advanced to a preselected final location e.g. a ditch 82. When the transferring assembly is properly aligned with the ditch, the forward end 64 of the peripheral section 61 holding the tensioned structure length is lowered into contact with the remote bank 83 of a ditch.

When the end of structure 72 is affixed in place by pressure roller 77, the transferring assembly 55 with the peripheral section thereon is withdrawn to place the full length of the structure into contact with the ditch bottom 84 and near bank 85. Uniform tension is maintained by adjusting the orientation of the rod members 62 and/or 63 as the transferring assembly is being withdrawn. Simultaneously therewith, roller 77 applies pressure to tightly bond the structure to the ditch surface 82.

Thereafter, additional lengths of the structure individually in succession are placed under tension, transferred to the same final location and placed in an overlapping relationship to the previous structure length and thereby form a continuous structural assembly of considerable length. Since each length is maintained under tension until installed into the ditch, the structural lining assembly produced is uniform and smooth without folds or other imperfections.

In the same way, the structural lengths may be transferred individually in succession to a plurality of spaced final locations. Likewise, a plurality of transferring assemblies 55 may be utilized.

The structure transferring assembly 55 may take a variety of forms depending upon the particular job and its site as well as the machinery available. For example, a platform transferable with a forklift mechanism, a wheeled carriage with or without power, and the like may be utilized.

Especially useful is a tractor with a forklift and/or backhoe attachment that can carry the tensioned structure to the final location. Other attachments can be incorporated on the machine e.g. cleaning brushes, patching mechanisms, etc. so that an operator can perform other duties on the return trip to the structure forming apparatus 11.

To produce high quality continuous composite structures of the invention, it is important that all of the steps be carefully coordinated by control portion 17. The control portion 17 of the structure forming apparatus 11 of the invention includes programmable memory means 88 and actuating means 89 responsive thereto in combination with coordinating means 90 to control the operation of the various components of apparatus 11. Preferably, the coordinating means includes a process controller 91 that initiates changes in the flows of materials and speeds of drives to bring variations therein back to the rates specified in the programs present in the memory 88.

This coordination commonly is achieved through the transmission of information such as digital pulses from monitors and/or sensors at the control components to the process controller 91. The operating information is compared with the preselected programming parameters stored in the memory 88. If differences are detected, instructions from the controller 91 change the operation of the components to restore the various operations to the preselected processing specifications.

The reactive resin forming materials employed to produce composite structures of the invention are selected to be capable of reaction to form the particular resin matrix or coating desired in the final structure. Advantageously, the materials form thermosetting resins such as a polyurethane or polyester. Should a polyurethane be desired, one reservoir may contain an isocyanate and another reservoir may contain a polyol.

More commonly, the reservoirs may contain different partially formed materials which upon mixing interact to form the desired polyurethane. Examples of such partially formed materials include so-called “A stage” resins and “B stage” resins.

Other resin forming systems may utilize a resin forming material in one reservoir and a catalyst and an inhibitor, each in other reservoirs. Additional components can be premixed with one of the resin formers, e.g. fillers, reinforcements, colors and the like.

The particulate solid additive material is mixed with the liquid reactive resin forming material substantially continuously, preferably, in a proportion significantly greater than that of the resin forming material. The additive particles may be any of a wide variety of inexpensive materials readily available at a particular job site. Natural mineral particulate materials such sand and gravel normally are available or can be produced simply by crushing rock at the site.

Also, materials such as waste or recycled materials which can be shredded or ground into particles of suitable size can be utilized. Especially useful are particles formed by shredding or grinding discarded tires. Since the particles are encapsulated with resin forming material and not saturated therewith, many different waste materials may be employed.

Suitable porous blankets include woven, knit, non-woven structures, etc. The blankets e.g. fabrics, mats, etc, may be formed of continuous or discontinuous fibers, yarns, slit ribbons and similar natural and synthetic fibrous materials. Reinforcing members such as ropes, cables and the like that extend longitudinally and/or transversely of the blanket centerline may be included if desired.

The above description and the accompanying drawings show that the present invention provides a novel method and apparatus which overcome the shortcomings of previous expedients and in addition, provide features and advantages not found in earlier technology.

The method and apparatus of the invention may be operated by individuals with only limited mechanical skills and experience to produce high quality structures safely and efficiently. The apparatus and method can be modified to form a variety of different structures.

It will be apparent that various modifications can be made in the particular apparatus and method described in detail above and shown in the drawings within the scope of the present invention. Components and procedures employed can be changed to meet specific process and structural requirements.

These and other changes can be made in the apparatus and method of the invention provided the functioning and operation thereof are not adversely affected. Therefore, the scope of the present invention is to be limited only by the following claims.

1. A method of forming a continuous composite structure including the steps of preselecting a liquid reactive resin forming material, a catalyst, an inhibitor, a particulate solid additive material and a porous blanket, measuring ambient temperature, determining relative proportions of said resin forming material, said catalyst and said inhibitor based on said ambient temperature and said porous blanket, mixing said additive particles with said predetermined proportions of said resin forming material, said catalyst and said inhibitor substantially continuously, encapsulating substantially all of said additive particles with said catalyzed and inhibited resin forming material, forming a pool of said mixture on said blanket while it is moving over an elongated arcuate surface disposed in a preselected orientation, advancing said mixture-treated blanket while migrating part of said catalyzed and inhibited resin forming material through said blanket substantially uniformly prior to gelling of said material to form a continuous resin matrix within said blanket, grasping a leading edge of said matrix/blanket along substantiallly its entire width, advancing said leading edge away from said arcuate surface along a preselected path, grasping opposite edges of a preselected length of said matrix/blanket structure, creating a preselected tension in said structure length, maintaining said tension while transferring said structure length to a final location, depositing said structure length on a final surface while said length is flexible and adhesive, and applying pressure to form a tight bond therebetween.

2. A method of forming a continuous composite structurre according to claim 1 including the step of maintaining said tension in said structure length while it is placed into contact with said final surface.

3. A method of forming a continuous composite structure according to claim 1 including the step of aligning said structure length in a preselected position before grasping opposite edges thereof and creating a preselected tension therein.

4. A method of forming a continuous composite structure according to claim 1 including the step of lowering said structure length into a preselected position prior to grasping opposite edges thereof.

5. A method of forming a continuous composite structure according to claim 1 including the step of grasping opposite transverse edges of said structure length.

6. A method of forming a continuous composite structure according to claim 1 including the step of transferring said tensioned structure length to a remote final location.

7. A method of forming a continuous composite structure according to claim 1 including the steps of successively grasping, tensioning and transferring a plurality of structure lengths to a common final location and depositing each structure length in an overlapping relationship to form a continuous structural assembly of considerable length.

8. A method of forming a continuous composite structure according to claim 1 including the steps of successively grasping, tensioning and transferring a plurality of structure lengths to a plurality of spaced final locations arranged in a preselected pattern and depositing each structure length in an overlapping relationship at each spaced final location to form a plurality of continuous structural assemblies arranged in a preselected pattern.

9. Continuous structure forming apparatus including a supporting portion, a material supplying portion, a mixing portion, a matrix forming portion, a positioning portion and a control portion; said supporting portion including a plurality of spaced upstanding frame members, a plurality of generally horizontally disposed frame members joining adjacent upper and lower ends of said upstanding frame members; said material supplying portion including a plurality of reservoirs operatively connected with said supporting portion, said reservoirs being connected independently with said mixing portion; said mixing portion including an elongated mixing chamber adjustably disposed adjacent said supporting portion; said matrix forming portion including mixture distributing means extending adjustably downwardly from said mixing chamber and being disposed adjacent an outlet thereof; said positioning portion including a generally horizontally disposed frame section extending from said supporting portion, said positioning portion including elongated structure grasping means translatably movable along said frame section, a structure transferring assembly alignable with said frame section including structure tensioning means; said control portion including programmable memory means, coordinating means, sensing means, actuating means, and circuitry transmitting signals from said sensing means to said coordinating means for comparison with said memory means and activation of said actuating means to form and place a continuous structure into a preselected final configuration while it is flexible and adhesive.

10. Continuous structure forming apparatus according to claim 9 wherein said elongated structure grasping means extends between and travels along spaced parallel side rails of said frame section.

11. Continuous structure forming apparatus according to claim 10 wherein said elongated structure grasping means includes a pair of cooperating hinged sections.

12. Continuous structure forming apparatus according to claim 9 wherein said structure tensioning means includes cooperating grasping means disposed along opposite edges of said structure transferring assembly.

13. Continuous structure forming apparatus according to claim 9 wherein said structure tensioning means includes a peripheral section including rod members along opposite sides thereof, a plurality of spaced outwardly extending pins along the length of each rod member, means selectively engaging said pins with said structure length adjacent opposite edges thereof and means for changing the spacing between pins of one rod member and pins of another rod member.

14. Continuous structure forming apparatus according to claim 13 wherein said means selectively engaging said pins with said structure length includes means rotating said rod members along axes thereof.

15. Continuous structure forming apparatus according to claim 9 wherein said structure transferring assembly includes a wheeled carriage.

16. Continuous structure forming apparatus according to claim 15 wherein said wheeled carriage includes drive means.

17. Continuous structure forming apparatus according claim 9 including pressure applying means disposed on said structure transferring assembly.

18. Continuous structure forming apparatus according to claim 17 wherein said pressure applying means includes a cantilevered pressure roller.

19. Continuous structure forming apparatus according to claim 18 wherein said pressure roller is supported on a free end of an extendable arm assembly mounted on a structure transferring driven vehicle.

20. Continuous structure forming apparatus according to claim 9 including outer shell sections selectively hung from said apparatus.
